(19) United States
(12) Patent Application Publication
(10) Pub. No.: US 2008/0295876 A1
(43) Pub. Date: Dec. 4, 2008

(54) Folding windscreen for ice fishing

(76) Inventor: Michael Ouellette, Auburn, ME (US)

Correspondence Address: Charles F. Seyboldt, 19 Ridgeview Drive, Standish, ME, 04084-5338, US

(21) Appl. No.: 11/810,038

(22) Filed: Jun. 4, 2007

(51) Int. Cl. A01K 97/01

(52) U.S. Cl. 135/87

(57) ABSTRACT

A folding windscreen having two panels can be made entirely from a single sheet of corrugated plastic. The windscreen is used to prevent wind-blown snow from clogging an ice-fishing hole and to enhance the visibility of ice fishing traps against a background shoreline or expanse of open ice. The single sheet of corrugated plastic material is made into two panels by folding it in half. The fold produces a flexible hinge connecting the two panels. The top and bottom edges of the windscreen panels are reinforced by folding parts of the corrugated sheet to make double thickness, and bonding the two thicknesses together with heat welding or adhesives. Hand-holes are provided for convenient carrying and deploying. Fluorescent or retro-reflective tape can be applied to the folding windscreen to enhance its visibility.

### BACKGROUND OF THE PRESENT INVENTION

### Summary of the Prior Art

This invention relates to a folding windscreen for ice fishing, and more particularly to a method of using a folding windscreen for ice fishing wherein the windscreen is inexpensive, lightweight, durable, and shaped to facilitate easy carrying to and from the fishing location.

The typical ice fishing activity involves making a hole in the ice, to access the water where the fish are. The fisherman then sets a line, oftentimes using a “trap.” An ice-fishing trap is a rod, bent from an upward vertical orientation, arranged so that when a fish takes the bait, the trap “springs,” setting the hook and elevating the rod. The rod will usually have a flag on it to alert the fisherman that the trap has sprung.

A single fisherman will usually make several holes and set several traps. As these ice fishing holes are exposed to the weather, winds tend to blow snow into the ice fishing holes, necessitating periodic removal. If the blown-in snow is not removed, it will interfere with the operation of the trap, and if left for enough time, the blown-in snow will re-freeze.

The typical measure taken to prevent the accumulation of blown-in snow is to build a wall on the up-wind side of the fishing hole, using snow taken from the surface of the frozen lake or pond. These snow-walls are usually short, e.g., about 150 millimeters (6 inches) tall, and are only moderately effective at stopping the accumulation of blown-in snow.

### SUMMARY OF THE PRESENT INVENTION

The present invention relates to a folding windscreen for ice fishing that may be adapted and adjusted to optimize size and raw material use, and further may be adapted by varying the width and/or height, use of colors, handhold configuration, hinge configuration, thickness or the corrugated raw material, and varying the size and fastening method used for the reinforcement ridges. Specific features of the invention will be apparent from the above and from the following description of the illustrative embodiments when considered with the attached drawings and the appended claims.

The folding windscreen for ice fishing is used to deflect wind from an ice fishing hole in order to prevent the accumulation of blown-in snow. If the fishing activity is taking place during a weather event that includes freezing rain or drizzle, the folding windscreen for ice fishing also prevents or retards the formation of an ice layer on the parts of the fishing trap.

Yet another benefit of the wind-deflecting attribute of the folding windscreen for ice fishing is that it blocks the wind for the fisherman at the time he or she is removing a fish from the fish hook and line. The fish removal activity usually requires the use of bare hands, and having bare hands exposed to winds results in rapid discomfort and stiffness. The folding windscreen reduces the amount of wind chill that will occur at and near the ice fishing hole.

A further benefit of using the folding windscreen for ice fishing is that the windscreen is more visible than an ice-fishing trap. An ice-fishing trap located at a distance from an observer is easily overlooked against a shoreline or in an expanse of open ice. The enhanced visibility of a folding windscreen compared with an ice-fishing trap reduces the chance that a fisherman will overlook one of his or her traps, once set. The folding windscreen for ice fishing thereby facilitates fishing a number of holes at greater distances from one another than could be reliably fished without the use of the folding windscreen.

The folding windscreen of the present invention has two panels, connected by a hinge. A folding windscreen is closed so that the two panels are “front-to-front,” making a thin package that is easy to carry for transportation to the ice fishing location. For use, the folding windscreen is opened so that the two panels make a “V” shape.

The folding windscreen can be provided with hand-holes (or hand-holds) to facilitate transportation. A number of folding windscreens can be stacked in the closed position, with their hand-holes in alignment. A cord or strap can be threaded through the hand-holes to bind the stack of windscreens together.

To use the folding windscreen for ice fishing, the fisherman locates and arranges the open windscreen upwind from an ice fishing hole and anchors it in place with the point of the “V” being located toward or into the wind. The open windscreen can be anchored against being moved by the force of wind by pushing it into already-present snow, or by piling snow, slush or the ice taken from making the fishing hole around its base.

The panels of the folding windscreen are made from a corrugated plastic material, where the hinge is aligned parallel with the flutes of the corrugated layer. This arrangement has the corrugation flutes running in the same direction that is referred to as the height of the panels. That is, looking at a windscreen from the top (before the reinforcing ridges are made), one would be see the wavy pattern presented by the ends of the corrugation flutes.

The top and bottom edges of the panels of the folding windscreen can be reinforced by scoring and bending a part of the corrugated material, to make the end parts of each panel into two thicknesses. The reinforced edges protect the otherwise edge-exposed corrugation layer against ingress of snow, water and ice. The doubled-over reinforced sections enhance the durability of the panels by preventing mechanical separation of the skin layers from the corrugated layer. The reinforced edges also, importantly, provide rigidity to the panels, so they resist deformation and vibration when subjected to the force of the wind.

Another moderate benefit attributable to the folded-over reinforced edges is the presentation of a smooth and rounded edge surface to the fisherman's hands when handling the panels, and especially when pushing the panels into the snow. Without the folded over reinforced edge, the top and bottom ends of the panel would present sharp edges (and an open view into the corrugation flutes) to the fisherman's hands.

A folding wind screen can be made from a single piece of corrugated material. The corrugated material has first and second skins separated by a corrugated layer. In this embodiment, the hinge between the panels is a flexible hinge. The flexible hinge is created by folding the full length of the corrugated material, in a direction parallel with the corrugation flutes. A straight-edge can be used to crease or partially crush the corrugated raw material along the line that will become the flexible hinge, and then bending or folding the raw material sheet along that line. The hinge proper is the folded crease of the combined first skin, crushed corrugated layer, and second skin. In the typical embodiment, the hinge is located so that it produces two panels of equal width.

The reinforced top and bottom edges of the panels can be made by creasing or crushing the first skin in a direction that is perpendicular to the corrugation flutes, without cutting through the first skin. In the typical embodiment, a crease is made about 50 millimeters (2 inches) from both the top and bottom edges, resulting in reinforcing ridges of about 50 millimeters (2 inch) width. Each crease divides the raw material into a body part and a reinforcing part.

The reinforcing part is folded along the crease, until the first skin of the reinforcing part comes in contact with the first skin of the body part, creating what amounts to a double thickness of corrugated material.

The reinforcing part can then be bonded to the body part by any one of a variety of means such as plastic “spot welding,” ultrasonic welding, infrared welding, adhesives, or mechanical fasteners such as grommets, rivets, or snaps.

The folding windscreen can be enhanced by providing strips of fluorescent color at the top, creating greater visibility in low-light conditions.

In summary, and in accordance with the above discussion, the foregoing objectives are achieved in the following embodiments.

1. A method for ice fishing that comprises:

providing a windscreen having first and second panels, where each of the two panels is made from corrugated plastic material having a front skin and a rear skin, and where the two panels are attached by a hinge;

arranging the windscreen so that the hinge is vertical and open to an angle between abut 45 and 270 degrees; and

placing the windscreen in proximity to an ice fishing hole.

2. A method for ice fishing as described in paragraph 1, where the two panels are made from a single piece of corrugated plastic material and the hinge is a flexible fold in the piece of corrugated plastic material.

3. A method for ice fishing as described in paragraph 1, where each panel further has an elongated hole arranged so that the hole in the first panel is in alignment with the hole in the second panel when the hinge is closed.

4. A method for ice fishing as described in paragraph 1, where each panel has a top and bottom edge, and where the top and bottom edges are reinforced.

5. A method for ice fishing as described in paragraph 4, where the reinforced top and bottom edges are provided by:

dividing each panel into an, upper reinforcing part, a central part, and lower reinforcing part by making an upper crease in the rear skin, parallel to the top edge and making a lower crease in the rear skin, parallel to the bottom edge;

folding the upper reinforcing part of each panel at the upper crease until the rear skin of the upper reinforcing part is in contact with the rear skin of the central part and bonding the upper reinforcing part to the central part; and

folding the lower reinforcing part of each panel at the lower crease until the rear skin of the lower reinforcing part is in contact with the rear skin of the central part and bonding the lower reinforcing part to the central part.

6. A method for ice fishing as described in paragraph 5, where each panel further has an elongated hole arranged so that the hole in the first panel is in alignment with the hole in the second panel when the hinge is closed.

7. A method for ice fishing as described in paragraph 2, where each panel has a top and bottom edge, and where the top and bottom edges are reinforced.

8. A method for ice fishing as described in paragraph 7, where the reinforced top and bottom edges are provided by:

dividing each panel into an upper reinforcing part, a central part, and lower reinforcing part by making an upper crease in the rear skin, parallel to the top edge and making a lower crease in the rear skin, parallel to the bottom edge;

folding the upper reinforcing part of each panel at the upper crease until the rear skin of the upper reinforcing part is in contact with the rear skin of the central part and bonding the upper reinforcing part to the central part; and

folding the lower reinforcing part of each panel at the lower crease until the rear skin of the lower reinforcing part is in contact with the rear skin of the central part and bonding the lower reinforcing part to the central part.

9. A method for ice fishing as described in paragraph 8, where each panel further has an elongated hole arranged so that the hole in the first panel is in alignment with the hole in the second panel when the hinge is closed.

10. A method for ice fishing as described in paragraph 9, where the panels are about 300 millimeters (1 foot) wide and about 600 millimeters (2 feet) tall.

11. A method for ice fishing as described in paragraph 9, where the panels are about 600 millimeters (2 feet) wide and about 600 millimeters (2 feet) tall.

### BRIEF DESCRIPTION OF THE DRAWINGS

FIG. 1 is a perspective view of a folding windscreen for ice fishing;

FIG. 2 is a perspective view of a raw material starting piece;

FIG. 3 is a perspective view of a three-piece folding windscreen;

FIG. 4 is a rear elevational view of a folding windscreen for ice fishing, with the panels in a full-open arrangement;

FIG. 5 is an elevational view of a folding windscreen for ice fishing, with the panels folded together;

FIG. 6 is a rear elevational view of a raw material starting piece;

FIG. 7a is a side elevational view of a raw material starting piece before the reinforcement fold is made;

FIG. 7b is a side elevational view of a raw material starting piece after the reinforcement fold is made.

FIG. 8 is a rear elevational view of a raw material starting piece.

### DESCRIPTION OF THE PREFERRED EMBODIMENTS OF THE PRESENT INVENTION

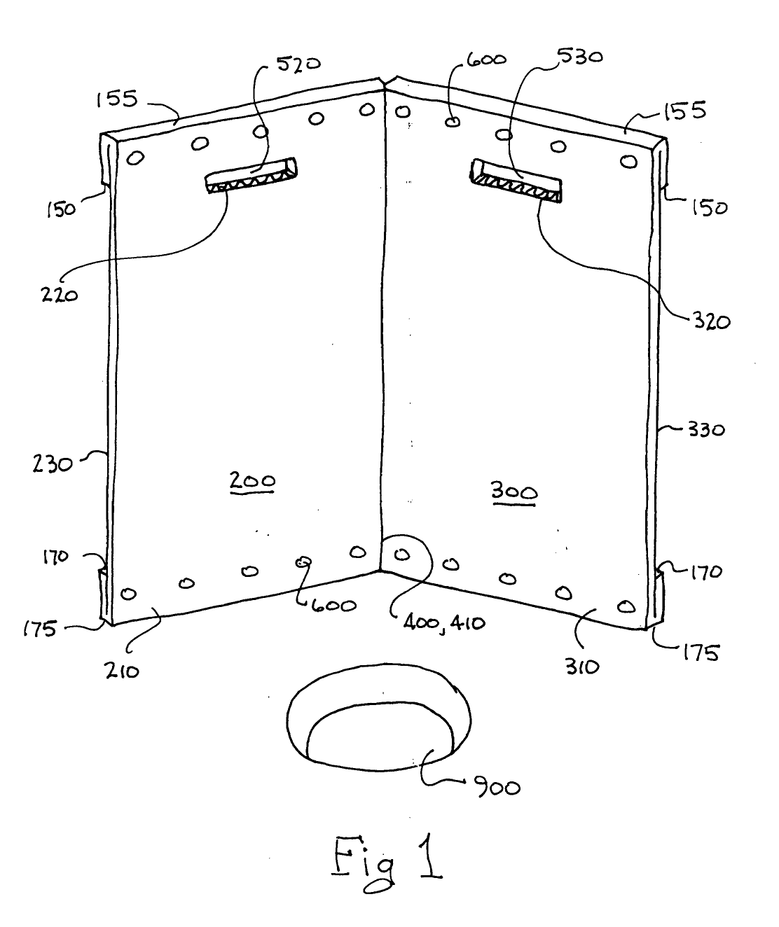

FIG. 1 is a perspective view of a folding windscreen for ice fishing.

The use of the folding windscreen is illustrated in FIG. 1. Panels 200 and 300 are arranged to an angle of about 100 degrees, with front skins 210 and 310 facing ice-fishing hole 900.

Left hand panel 200 and right hand panel 300 are fastened together by flexible hinge 400. Panels 200 and 300 are preferably made from a corrugated plastic material [thickness, other specifications of the material].

Flexible hinge 400 has an inside crease 410 and an outside edge 430 (shown in later figures).

Panels 200 and 300 are preferably from about 300 mm (1 foot) to about 600 mm (2 feet) wide, and about 600 mm (2 feet) tall. This choice of size results in no waste if the panels are cut from a 1220 mm by 2440 mm (4 by 8 foot) piece of raw material.

Panel 200 has a front skin 210 and rear skin 230, separated and held together by internal corrugation 220. Panel 300 likewise has a front skin 310 and rear skin 330, separated by internal corrugation 320. In the preferred embodiment, panels 200 and 300 are made from a single piece of corrugated raw material, so that front skins 210 and 310 are actually a single skin, with common edges defined by the inside of flexible hinge 400, and rear skins 230 and 330 are actually a single skin, with common edges defined by the outside edge 430 (shown in later figures) of flexible hinge 400.

FIG. 2 is a perspective view of a raw material starting piece.

The preferred method of producing flexible hinge 400 involves two steps. The first step is to make inside crease 410 in front skin 110 and internal corrugation 120 of the raw material starting piece 100, in the direction that is parallel with the corrugation flutes 120. Before the raw material starting piece 100 is creased, front skins 210 and 310 are a contiguous planar surface 110. The second step is to fold the raw material by making a 180 degree rotation of either panel 200 or 300 about the axis of seam 400. At the conclusion of this rotation, front skin 210 will be in contact with front skin 310. This position is referred to as “closed,” “closed hinge,” or “folded,” and is the most convenient position for transporting the folding wind screen.

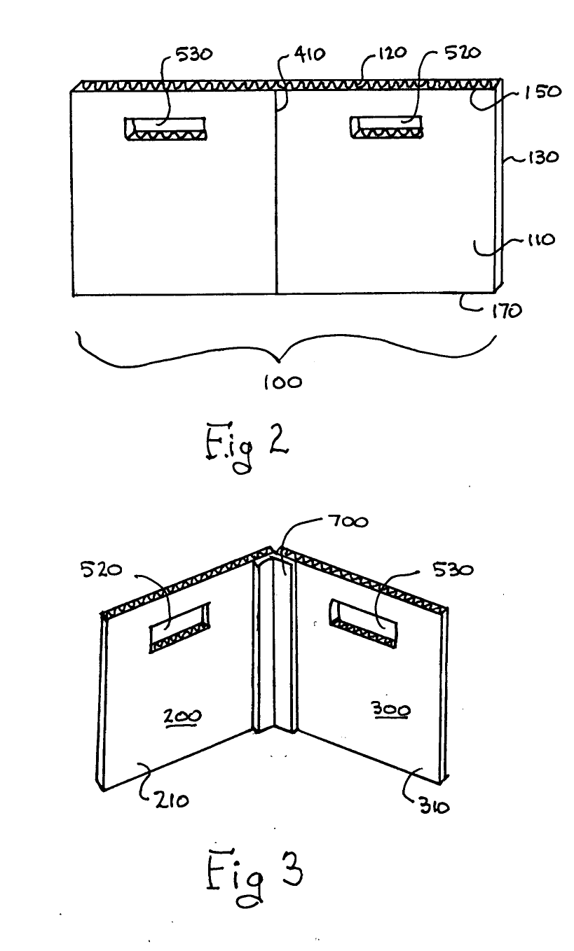

FIG. 3 is a perspective view of a three-piece folding windscreen.

In another embodiment, panels 200 and 300 are entirely separate pieces of corrugated plastic, and are connected by a separate piece, e.g., a fabric or plastic piece 700 that is bonded to front skins 210 and 310. An adhesive backed tape, such as duct tape, could be used for this purpose.

A hybrid or reinforced hinge is also foreseen to be within the scope of the present invention, where a flexible hinge 400 is made by creasing rear skin 130 and rotating one panel (200 or 300) to fold the raw material, accompanied by affixing a reinforcing tape 700 overlapping inside crease 410 and parts of front skins 210 and 310. The reinforcing tape could be bonded either before or after folding the corrugated raw material sheet 100 to create flexible hinge 400.

In similar fashion (not illustrated), outside edge 430 of flexible hinge 400 can be reinforced with a separate piece of reinforcing tape.

While any type of hinge can be used to practice the ice fishing method of the present invention, the flexible hinge that is simply the result of creasing and folding the sheet of corrugated raw material is the most cost effective method for producing two panels connected by a hinge, and the preferred embodiment does not use any reinforcement.

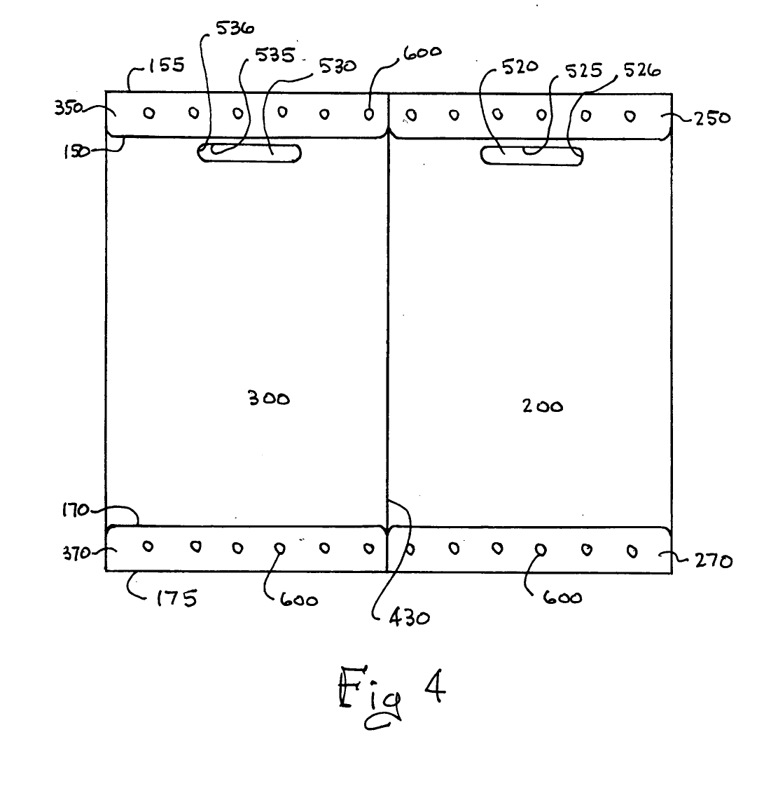

FIG. 4 is a rear elevational view of a folding windscreen for ice fishing, with the panels in a full-open arrangement.

In its preferred embodiment, the folding windscreen has hand holes 520 and 530. Hand holes 520 and 530 are located so their top edges 525, 535 are about 50 millimeters (2 inches) away from top edge 155 of the folding windscreen. Hand holes 520 and 530 are about 37 millimeters (1½ inch) tall and about 150 millimeters (6 inches) wide, and have full radius ends 526, 536. Hand holes 520, 530 are preferably produced by using a metal die to punch through the corrugated material. The size, shape and location of hand holes 520, 530 can be varied.

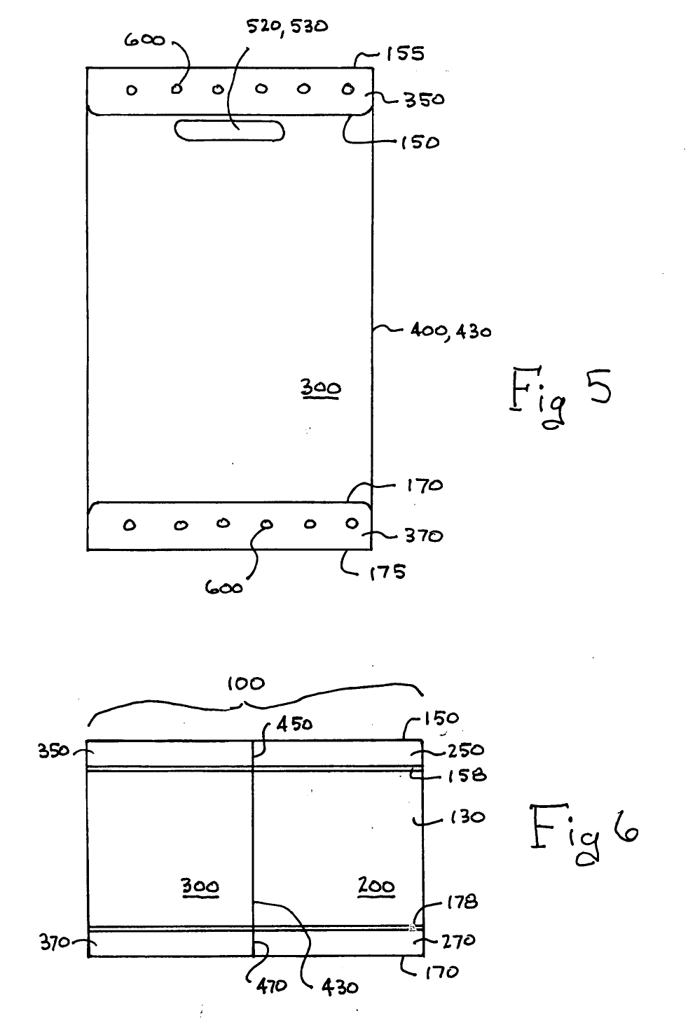

FIG. 5 is an elevational view of a folding windscreen for ice fishing, with the panels folded together.

As shown in FIG. 5, hand holes 520, 530 are made of similar size and location, so that when panels 200 and 300 are folded together (flexible hinge 400 being “closed”), all of the edges that define hand holes 520 and 530 are aligned.

In this configuration, outside crease 430 of flexible hinge 400 is exposed.

FIG. 6 is a rear elevational view of a raw material starting piece.

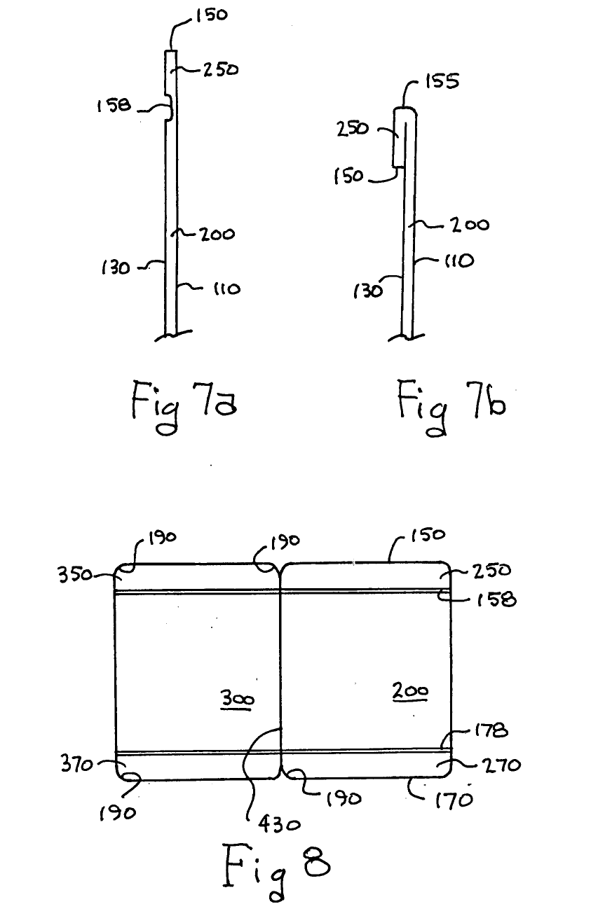

FIG. 7a is a side elevational view of a raw material starting piece before the reinforcement fold is made.

FIG. 7b is a side elevational view of a raw material starting piece after the reinforcement fold is made.

A piece of raw material 100 has top edge 150 and bottom edge 170, and as described above, panels 200 and 300 and flexible hinge 400 can be made by making a inside crease 410 through front skin 110, in a direction that is parallel with the corrugation flutes (not shown) then folding the piece of raw material 100 in half. In the preferred embodiment, the top and bottom edges of panels 200 and 300 will be reinforced.

Crease 158 deforms rear skin 130, and runs parallel with raw material top edge 150. Crease 158 is located about 50 millimeters (2 inches) from raw material top edge 150. Crease 158 delineates upper reinforcing portion 250 of panel 200, and also delineates upper reinforcing portion 350 of panel 300, where the upper reinforcing portions 250 and 350 are about 50 millimeters tall and run the full width of panels 200 and 300.

Upper cut 450 is made through skins 110 and 130 as well as through corrugated layer 120, from upper edge 150 of the raw material to crease 158, with upper cut 450 being collinear with hinge 400 (also represented by inside crease 410 and outside edge 430). Upper cut 450 separates upper reinforcing portion 250 from upper reinforcing portion 350.

Crease 158 is of sufficient depth from rear skin 130 to deform the corrugated layer 120, but not of such depth so as to cause deformation of front skin 110 of the raw material blank. After crease 158 is made, the reinforced top edge 155 of panel 200 is produced by folding upper reinforcing portion 250 about crease 158, with reinforced top edge 155 originally being front skin 110. Reinforced top edge 155 of panel 300 is likewise made by folding upper reinforcing portion 350 about crease 158.

Reinforced bottom edges 175 are made in the same way as reinforced top edges 155, with crease 178 deforming rear skin 130, and running parallel with and at a distance of about 50 millimeters (2 inches) from raw material lower edge 170.

Crease 178 delineates lower reinforcing portion 270 of panel 200, and also delineates lower reinforcing portion 370 of panel 300, where the lower reinforcing portions 270 and 370 are about 50 millimeters tall and run the full width of panels 200 and 300.

Lower cut 470 is made through skins 110 and 130 as well as through corrugated layer 120, from lower edge 170 of the raw material to crease 178, with lower cut 470 being collinear with hinge 400 (also represented by inside crease 410 and outside edge 430). Lower cut 470 separates lower reinforcing portion 270 from lower reinforcing portion 370.

After crease 178 is made, the reinforced bottom edge 175 of panel 200 is produced by folding lower reinforcing portion 270 about crease 178, with reinforced bottom edge 175 originally being front skin 110. Reinforced bottom edge 175 of panel 300 is likewise made by folding reinforcing portion 370 about crease 178.

Reinforcing panels 250, 350, 270 and 370 are preferably bonded to panels 200 and 300 with plastic spot welds 600, located on about 75 millimeter (3 inch) centers. The spot welds that are closest to the side edges of panels 200 and 300 are preferably less than 25 millimeters (1 inch) away from those side edges, in order to prevent the ends of the reinforcing portions from separating from the panels.

FIG. 8 is a rear elevational view of a raw material starting piece.

In the preferred embodiment, the corners of upper reinforcing panels 250 and 350, and of lower reinforcing panels 270 and 370, are radiused. Radiused corners 190 are provided at eight locations, two on each reinforcing panel. The radiused corners can be produced by die cutting. The preferred radius is about 8 millimeters (⅜ inch).

In alternative embodiments (not illustrated), reinforcing panels 250, 350, 270 and 370 can be bonded to panels 200 and 300 using ultrasonic welding, infrared welding, or any suitable type of adhesive. Mechanical bonding using metal fasteners such as rivets or grommets is also foreseen to be within the scope of the present invention.

While the preferred embodiment has both top and bottom edges reinforced, the practice of the present invention can be done with no reinforcement of the top or bottom edge, or with reinforcement only at the top edge, or only at the bottom edge.

The preferred color for the folding windscreen is royal (dark) blue. Light colors tend to blend in with shoreline features, the horizon, and open expanse of ice and snow; while bright colors such as red or orange obscure the flag signal presented when an ice fishing trap is sprung.

However, bright colored or retro-reflective tape can be affixed to the top edge of a folding windscreen in order to provide increased visibility in low light, night, wind-blown snow, or foggy weather conditions.

The present invention, described above, relates to a folding windscreen for ice fishing. Features of the present invention are recited in the appended claims. The drawings contained herein necessarily depict structural features and embodiments of the folding windscreen for ice fishing, useful in the practice of the present invention.

However, it will be appreciated by those skilled in the arts pertaining thereto, that the present invention can be practiced in various alternate forms, proportions, and configurations. Further, the previous detailed descriptions of the preferred embodiments of the present invention are presented for purposes of clarity of understanding only, and no unnecessary limitations should be implied therefrom. Finally, all appropriate mechanical and functional equivalents to the above, which may be obvious to those skilled in the arts pertaining thereto, are considered to be encompassed within the claims of the present invention.

What I claim is:

1. A method for ice fishing that comprises:
providing a windscreen having first and second panels, where each of the two panels is made from corrugated plastic material having a front skin and a rear skin, and where the two panels are attached by a hinge;
arranging the windscreen so that the hinge is vertical and open to an angle between abut 45 and 270 degrees; and
placing the windscreen in proximity to an ice fishing hole.

2. A method for ice fishing as described in claim 1, where the two panels are made from a single piece of corrugated plastic material and the hinge is a flexible fold in the piece of corrugated plastic material.

3. A method for ice fishing as described in claim 1, where each panel further has an elongated hole arranged so that the hole in the first panel is in alignment with the hole in the second panel when the hinge is closed.

4. A method for ice fishing as described in claim 1, where each panel has a top and bottom edge, and where the top and bottom edges are reinforced.

5. A method for ice fishing as described in claim 4, where the reinforced top and bottom edges are provided by:
dividing each panel into an upper reinforcing part, a central part, and lower reinforcing part by making an upper crease in the rear skin, parallel to the top edge and making a lower crease in the rear skin, parallel to the bottom edge;
folding the upper reinforcing part of each panel at the upper crease until the rear skin of the upper reinforcing part is in contact with the rear skin of the central part and bonding the upper reinforcing part to the central part; and
folding the lower reinforcing part of each panel at the lower crease until the rear skin of the lower reinforcing part is in contact with the rear skin of the central part and bonding the lower reinforcing part to the central part.

6. A method for ice fishing as described in claim 5, where each panel further has an elongated hole arranged so that the hole in the first panel is in alignment with the hole in the second panel when the hinge is closed.

7. A method for ice fishing as described in claim 2, where each panel has a top and bottom edge, and where the top and bottom edges are reinforced.

8. A method for ice fishing as described in claim 7, where the reinforced top and bottom edges are provided by:
dividing each panel into an upper reinforcing part, a central part, and lower reinforcing part by making an upper crease in the rear skin, parallel to the top edge and making a lower crease in the rear skin, parallel to the bottom edge;
folding the upper reinforcing part of each panel at the upper crease until the rear skin of the upper reinforcing part is in contact with the rear skin of the central part and bonding the upper reinforcing part to the central part; and
folding the lower reinforcing part of each panel at the lower crease until the rear skin of the lower reinforcing part is in contact with the rear skin of the central part and bonding the lower reinforcing part to the central part.

9. A method for ice fishing as described in claim 8, where each panel further has an elongated hole arranged so that the hole in the first panel is in alignment with the hole in the second panel when the hinge is closed.

10. A method for ice fishing as described in claim 9, where the panels are about 300 millimeters (1 foot) wide and about 600 millimeters (2 feet) tall.

11. A method for ice fishing as described in claim 9, where the panels are about 600 millimeters (2 feet) wide and about 600 millimeters (2 feet) tall.
